(19) United States
(12) Patent Application Publication
(10) Pub. No.: US 2017/0075453 A1
(43) Pub. Date: Mar. 16, 2017

(54) TERMINAL AND TERMINAL CONTROL METHOD

(71) Applicant: Sharp Kabushiki Kaisha, Sakai City, Osaka (JP)

(72) Inventor: Mitsuhiro NAKAIZUMI, Sakai City (JP)

(21) Appl. No.: 15/310,494

(22) PCT Filed: May 7, 2015
(86) PCT No.: PCT/JP2015/063186

§ 371 Date: Nov. 11, 2016

(30) Foreign Application Priority Data
May 16, 2014 (JP) 2014-102521

(51) Int. Cl. G06F 3/044; G06T 7/20

(52) U.S. Cl. CPC G06F 3/044; G06T 7/20; G06T 2200/24

(57) ABSTRACT

A terminal includes: a detector that detects contact by a part of a finger at a prescribed location on a display of the terminal and that detects a shape of the finger held over the display; and an image controller that, based on a detection result detected by the detector, moves an image displayed on the display by parallel movement.

### TECHNICAL FIELD

The present invention relates to a terminal and a terminal control method.

The subject application claims priority based on the patent application No. 2014-102521 filed in Japan on May 16, 2014 and incorporates by reference herein the content thereof.

### BACKGROUND ART

In a mobile terminal such as a smartphone that has a touch panel on the screen, relatively large screen sizes, such as a 5-inch-class one have been implemented. If a user holds the mobile terminal in one hand and operates the touch panel with the same hand, there have been cases in which fingers could not reach an icon displayed on the screen, even when fully extended. For that reason, based on an image detected by a sensor built into the display panel the orientation of a user's finger that has come close to or contacted the display panel is detected, and an icon to be displayed at the detected fingertip is selected. It has been proposed that, with respect to an icon displayed in a region that the user's finger cannot reach, the user slides the finger in the direction of that icon, so as to switch the icon to be selected (refer to, for example, Patent Document 1).

The range that the thumb of the user's hand that is gripping the terminal is set as an expanded operation area, and the touch point coordinates are converted so that an actual touch input within the expanded operation area becomes a virtual touch input to the entire range of the touch panel. It has been proposed that an operation in the expanded operation area and operation in the remaining normal operation area be switched by modes, with a touch point for an operation in the normal operation area not being converted (refer to, for example, Patent Document 2).

### PRIOR ART DOCUMENTS

### Patent Documents

[Patent Document 1] Japanese Patent Application Publication No. 2010-122972

[Patent Document 2] Japanese Patent Application Publication No. 2012-137837

### SUMMARY OF THE INVENTION

### Problem to be Solved by the Invention

However, with the art described in Patent Document 1 and Patent Document 2, in order to select an icon displayed in a region that the finger does not reach, it has been necessary for the user to make a plurality of operations that differ from normal operations. With the art described in Patent Document 1, if a plurality of icons are displayed in a region that the finger does not reach, in order to select an icon from thereamong, the user might need to slide the finger a plurality of times, the operation thus becoming troublesome. With the art described in Patent Document 1, even if an icon can be selected and the function associated with the selected icon can be executed, it is not possible to make a drag operation or a swipe operation with respect to an image displayed in a region that the finger does not reach.

With the art described in Patent Document 2, in an operation on the expanded operation area it has been necessary to take care that the finger is not allowed to extend to outside that area. Because the expanded operating area is a reduced area set to a range within the overall touch panel set to a range that the finger of the user reaches, fine drag and tapping operations and the like are difficult. With the art described in the Patent Document 2, because a special region is disposed, it has been necessary to overlap with an existing user interface, or to establish the special region and modify the makeup of the existing screen.

In this manner, the art described in Patent Document 1 and Patent Document 2 had the problem of poor operation of a terminal having a large screen, with the finger could not reach when it is held by one hand.

One aspect of the present invention is made in consideration to the above-noted problem, and has as an object to provide a terminal and a terminal control method with improved single-handed operation, even for a large screen that the finger cannot reach when held with one hand.

### Means for Solving the Problems

To achieve the above-described object, a terminal according to one aspect of the present invention includes: a detector that detects contact by a part of a finger at a prescribed location on a display of the terminal and that detects a shape of the finger held over the display; and an image controller that, based on a detection result detected by the detector, moves an image displayed on the display by parallel movement.

### Effect of the Invention

According to one aspect of the present invention, one-hand operation is improved, even for a large screen that the finger cannot reach when held with one hand.

### BRIEF DESCRIPTIONS OF THE DRAWINGS

FIG. 1 is an oblique view showing an example of the outer appearance of a terminal according to a first embodiment.

FIG. 2 is a block diagram describing the general constitution of a terminal according to the first embodiment.

FIG. 3 is a drawing describing the state in which a user holds a terminal in one hand.

FIG. 4 is a drawing describing an example of a region pre-established as a frame of a touch panel according to the first embodiment.

FIG. 5 is a drawing describing hovering.

FIG. 6 is a drawing describing a prescribed position and coordinates on the display in the first embodiment.

FIG. 7 is a flowchart of the processing procedure according to the first embodiment.

FIG. 8A is a first drawing describing an example of the processing according to the first embodiment.

FIG. 8B is a second drawing describing an example of the processing according to the first embodiment.

FIG. 8C is a third drawing describing an example of the processing according to the first embodiment.

FIG. 8D is a fourth drawing describing an example of the processing according to the first embodiment.

FIG. 8E is a fifth drawing describing an example of the processing according to the first embodiment.

FIG. 8F is a sixth drawing describing an example of the processing according to the first embodiment.

FIG. 9 is a flowchart of the processing procedure according to the second embodiment.

FIG. 10A is a first drawing describing an example of the processing according to the second embodiment.

FIG. 10B is a second drawing describing an example of the processing according to the second embodiment.

FIG. 10C is a third drawing describing an example of the processing according to the second embodiment.

FIG. 10D is a fourth drawing describing an example of the processing according to the second embodiment.

FIG. 11A is a first drawing describing an example of the processing according to the second embodiment.

FIG. 11B is a second drawing describing an example of the processing according to the second embodiment.

FIG. 11C is a third drawing describing an example of the processing according to the second embodiment.

FIG. 11D is a fourth drawing describing an example of the processing according to the second embodiment.

### EMBODIMENTS FOR CARRYING OUT THE INVENTION

Embodiments of the present invention will be described below, with references made to the drawings. The present invention is not restricted to these embodiments and may be subjected to various modifications, modifications thereof all being encompassed in the technical scope of the claims for patent.

### First Embodiment

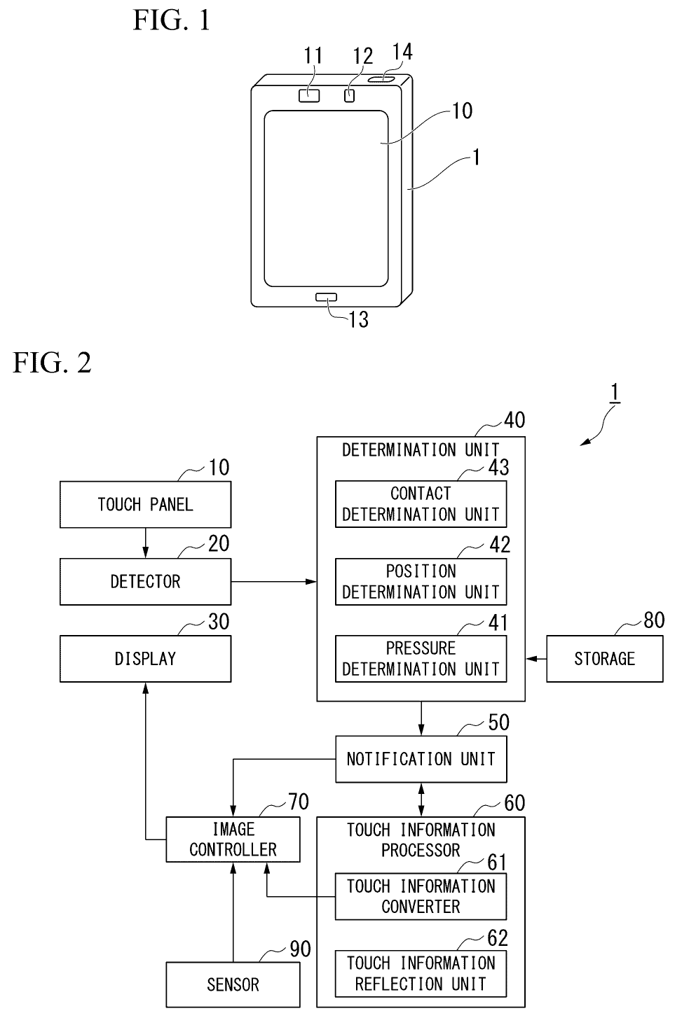

FIG. 1 is an oblique view showing an example of the outer appearance of a terminal 1 according to the present embodiment. The terminal 1 has a flat rectangular shape, the majority of one of the main surfaces thereof being occupied by a touch panel 10. For example, the upper edge part of the terminal 1 is provided with a speaker 11, a camera 12, and a power switch 14, and the lower edge part thereof is provided with a microphone 13. A CPU, a storage device that stores a computer program or the like, various interfaces, and an antenna and the like are provided inside the terminal 1.

FIG. 2 is a block diagram describing the general constitution of the terminal 1 according to the present embodiment.

As shown in FIG. 2, the terminal 1 has as major elements a touch panel 10, a detector 20, a display 30, a determination unit 40, a notification unit 50, a touch information processor 60, an image controller 70, a storage 80, and a sensor 90. The determination unit 40 has a pressure determination unit 41, a position determination unit 42, and a contact determination unit 43. The touch information processor 60 has a touch information converter 61 (converter) and a touch information reflection unit 62. The terminal 1 is a device having a touch panel, such as a mobile telephone, a tablet terminal, a music player, a portable car navigation device, a wireless communication terminal with a portable router function, or a portable game machine.

The touch panel 10 accepts a touch operation by the user and outputs touch operation information indicating the accepted touch operation to the detector 20. The touch panel 10 detects contact on the screen of the display 30 and accepts operation input from a user. One example of a detection system for both touch operations and floating touch operations of the touch panel 10 is a projected capacitive touch system. However, touch operations and floating touch operations can be recognized by the degree of capacitance change in a projected capacitive touch system.

The detector 20 detects that a touch operation has been made. For example, if the touch panel is a capacitive type, the detector 20, in response to a touch operation with respect to the touch panel 10, acquires a change amount of the capacitance detected by the touch panel 10, and detects that the touch operation has been made, based on the acquired amount of change of the capacitance. In the following description, the amount of change of the capacitance detected by the touch panel 10 will be called the touch detection amount. The detector 20 has input thereto a pressured detection value, input from a pressure sensor. The touch detection amount and the pressure detection amount include information indicating the touched position. In this case, position information is, for example, the coordinates established on the touch panel 10. The detector 20 outputs the detected touch detection amount and pressure detection value as the detection results to the determination unit 40.

The display 30 has, for example, a liquid crystal panel or an organic EL display panel and displays images, including icon, output from the image controller 70. An icon is an image (symbolic representation) indicating an application that is installed (or embedded) into the storage 80 of the terminal 1. The icons displayed on the display 30 may be automatically laid out by the image controller 70, or may be laid out by the user. The touch panel 10 and the display 30 are thin and substantially rectangular elements that are overlapped on each other to form one unit. The touch panel 10 and the display 30 may alternatively be integrated as one.

The sensor 90 detects whether the terminal 1 is being held in portrait format or landscape format, and outputs to the image controller 70 the detection result.

The pressure determination unit 41 determines whether or not the touch panel 10 has been pressed by whether the pressure detection value input from the detector 20 exceeds a pre-established value. The pressure determination unit 41 outputs the determination result to the contact determination unit 43. If the touch panel 10 is a capacitive touch type, the pressure determination unit 41 may detect the pressure by a pressure sensor (not shown) disposed in the periphery of the touch panel 10. In the case of a hybrid type touch panel 10 combining a capacitive touch type and a resistive film, the pressure determination unit 41 may detect the pressure by detecting a resistance value that changes in accordance with a resistive film.

The position determination unit 42 detects the position on the touch panel 10 at which it was determined by the pressure determination unit 41 had been pressed. The position determination unit 42 detects the position on the touch panel 10 which the contact determination unit 43 determined had been touched. The position determination unit 42 outputs the determination result to the contact determination unit 43.

The contact determination unit 43 determines whether or not the base of the thumb (ball of the thumb) is in contact with the pre-established peripheral part (frame) of the touch panel 10. The contact determination unit 43 determines whether or not the finger has come into contact with (touched) the touch panel 10. The contact determination unit 43 determines whether or not the base of the thumb of the user is in contact with the frame of the touch panel 10 and also the thumb is not in contact with the touch panel 10 but is held thereover (hovering). If the thumb is in the hovering state and also the condition of the thumb being extended is satisfied, the contact determination unit 43 detects the coordinates of the position of the tip of the thumb by detecting the hovering. As will be described later, after the image on the display 30 moves, the contact determination unit 43 detects that the thumb has touched the touch panel 10 and detects the touched position based on the determination results from the contact determination unit 43. Hovering and hover detection will be described later. The contact determination unit 43 outputs to the notification unit 50 information indicating the coordinates of the position of the base of the thumb, information indicating the position of the tip of the thumb, trigger information indicating that the thumb is extended over the touch panel 10, and the touch detection amount input from the detector 20. The trigger information acts as the trigger to start movement of the image within the display 30.

The determination performed by the contact determination unit 43 will now be described.

If, based on the determination result of the position determination unit 42, the position at which the touch panel 10 has been touched is the frame of the touch panel 10 and also the touched position has a prescribed surface area when grouped using a widely known method, the contact determination unit 43 determines that the base of the thumb has touched the frame of the touch panel 10. Alternately, if the position which the pressure determination unit 41 determines has been pressed is the frame of the touch panel 10 and also the pressed position has a prescribed surface area when grouped using a widely known method, the contact determination unit 43 determines that the base of the thumb has touched the frame of the touch panel 10. If the pressed region detected by the pressure determination unit 41 is larger than a prescribed surface area or the detected pressure is smaller than a prescribed value, the contact determination unit 43 determines that the touch was a mistaken touch. A mistaken touch is a condition of a case in which the user touches the touch panel 10 unintentionally, for example, when the user is holding the terminal 1 so that the touch panel 10 comes into contact with the palm.

The contact determination unit 43, based on information indicating the shape of the thumb stored in, for example, the storage 80, performs hover detection to determine whether or not the thumb is hovering over the touch panel 10 and determine whether or not the thumb is extended.

The fingertip position determination, the hovering state determination, and the determination of the extension of the thumb may be performed using an image captured by the camera 12.

Information indicating the coordinates of the position of the base of the thumb, information indicating the position of the tip of the thumb, trigger information, and the touch detection amount are input to the notification unit 50 from the determination unit 40. If the trigger information is input, the notification unit 50 generates movement start information that indicates the starting of movement of an image within the display 30 and outputs information indicating the coordinates of the position of the base of the thumb, information indicating the position of the tip of the thumb, and the generated movement start information to the image controller 70. After inputting triggering information as will be described later, when the prescribed processing is completed, the notification unit 50 generates movement stop information indicating the stopping of movement of the image within the display 30, and outputs the generated movement stop information to the image controller 70. The notification unit 50 outputs the movement start information and the touch detection amount to the touch information processor 60.

If the movement start information is not input from the notification unit 50, the touch information converter 61 outputs to the touch information reflection unit 62 the coordinates included in the input touch detection amount without converting them. If the movement start information is input from the notification unit 50, the touch information converter 61 converts the coordinates included in the input touch detection amount and outputs the converted coordinates to the touch information reflection unit 62.

The touch information reflection unit 62, based on the coordinates input from the touch information converter 61, performs processing with respect to the image on the display 30. If there is one set of coordinates input within a prescribed amount of time, the touch information reflection unit 62 determines that a tap operation has been made on the display 30, and performs processing that is performed when a tap is made. If different coordinates are successively input within a prescribed amount of time, the touch information reflection unit 62 determines that a finger has made a slide and performs slide processing of the image. If the same coordinates are input repeatedly during a prescribed amount of time, the touch information reflection unit 62 determines that a long press has been made on the display 30 and causes display of a menu or selected image or the like corresponding to those coordinates.

The image controller 70, in accordance with the detection results input from the sensor 90, displays an image on the display 30. The image controller 70, in accordance with the detection results input from the sensor 90, controls the detection of coordinates, the calculation of the vector V for moving the image, and the movement of the image. If movement start information is input form the notification unit 50, the image controller 70, based on information indicating the coordinates of the position of the base of the thumb and information indicating the position of the tip of the thumb input from the notification unit 50, moves the image displayed on the display 30 to a prescribed position. The prescribed position is a region on the display 30 that the thumb of the user holding the terminal 1 can reach. The image controller 70 calculates this prescribed position, based on the detected position of the base of the thumb and the position information of the tip of the thumb. If the movement stop information has been input from the notification unit 50, the image controller 70 returns the image that had been moved to the prescribed position to the original position.

The storage 80 stores the detection region set with respect to the frame of the touch panel 10 and information indicating the shape of the thumb.

The processing performed in the present embodiment will now be described.

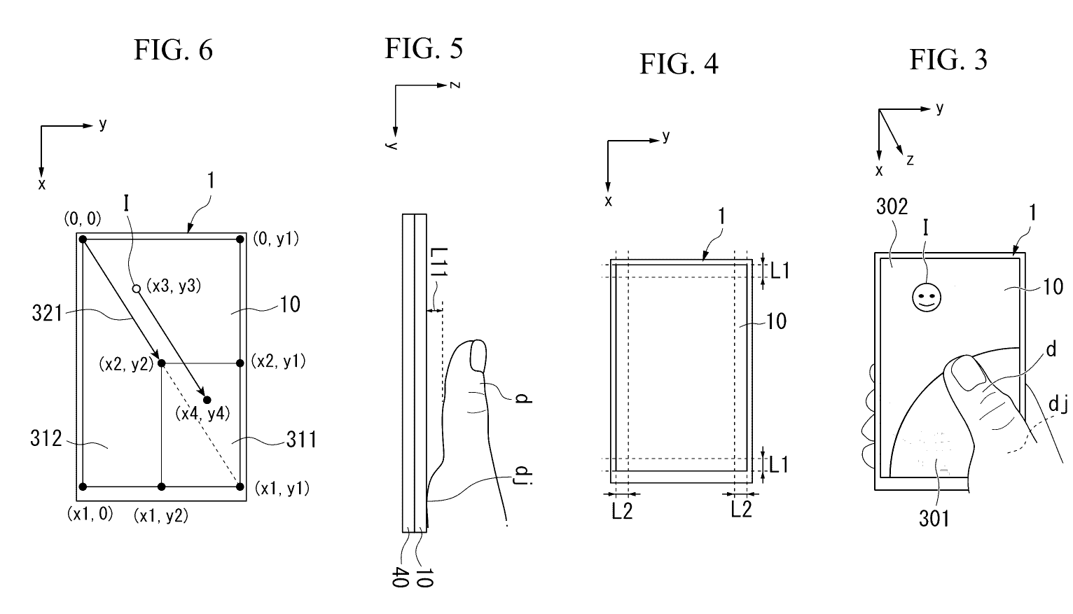

FIG. 3 describes the state in which a user holds the terminal 1 in one hand. As shown in FIG. 3, if the vertical/horizontal length of the terminal 1 of the present embodiment is shorter than twice that of, for example, the thumb of the user. The terminal 1 is, for example, a smartphone with a 5-inch-class display 30. In the following, the description is, for example, for the case of operation with the terminal 1 held in the right hand, with the display 30 in portrait format. In FIG. 3, the touch panel 10 is viewed from above the touch panel in the state in which the tip of the thumb does not touch the touch panel 10. In FIG. 3, the long-side direction of the display 30 is taken to be the x-axis direction, the short-side direction thereof is taken to be the y axis, and the thickness direction of the terminal 1 is taken to be the z axis. In FIG. 3, to simplify the description, the display 30 is shown for the case of displaying one icon.

In FIG. 3, the image indicated by the reference symbol d is the thumb of the user's right hand. The image indicated by the reference symbol dj is the base (ball) of the thumb of the user's right hand. The image indicated by the reference symbol I is an icon that is displayed on the display 30. The region indicated by the reference symbol 301 is the region that can be operated in by the right thumb, and that indicated by the reference symbol 302 is a region in which the right thumb cannot perform operations. If the terminal 1 is held to be operated in one hand, the user, as shown in FIG. 3, rests the terminal 1 in the palm of the hand and holds it between the palm and the base of the thumb. The user then touches the display 30 with the thumb, while continuing to hold the terminal 1. In the example shown in FIG. 3, the thumb does not reach the icon I displayed on the display 30.

FIG. 4 describes an example of a region set beforehand as a frame of the touch panel 10 according to the present embodiment. In FIG. 4, the long-side direction of the display 30 is taken to be the x axis, and short-side direction thereof is taken to be the y axis. As shown in FIG. 4, in the frame of the touch panel 10, a region of the terminal 1 surrounded by a width of L1 in the x-axis direction from the edges of the terminal 1 and by a width of L2 in the y-axis direction from the edges thereof is set beforehand as a position for determining whether or not the base of the thumb is making contact. Information of this region is stored into either the storage 80 or the position determination unit 42.

FIG. 5 describes hovering. FIG. 5 shows the touch panel viewed from the side, with the tip of the thumb not touching the touch panel 10. In FIG. 5, the short-side direction of the display 30 is taken to be the y axis, and the thickness direction of the terminal 1 is taken to be the z axis. As shown in FIG. 5, the finger is at a distance of L11 from the touch panel 10 and is not making contact therewith, this being called the hovering state, and the detection of this state is called hover detection. In hover detection, if the touch panel 10 is a capacitive touch type, based on, for example, a pre-established threshold of capacitance, detection is made of whether a finger is touching the touch panel 10 or whether it is in the hovering state, and whether there is no finger over the touch panel 10.

FIG. 6 describes a prescribed position and the coordinates on the display 30 in present embodiment. In FIG. 6, the long-side direction of the display 30 is taken to be the x axis, and the short-side direction thereof is taken to be the y axis. For example, if the number of pixels of the display 30 is y1×x1 dots, the coordinates of the upper-left of the display 30 are the origin (0, 0), those of the upper-right are (0, y1), those of the lower-left are (x1, 0), and those of the lower-right are (x1, y1).

In FIG. 6, the region indicated by the reference symbol 311 is the region to which an image on the display 30 is moved and displayed, and the region indicated by the reference symbol 312 is another region. As shown in FIG. 6 the region to which an image displayed on the display 30 is to be moved and displayed is surrounded by the points (x2, y2), (x2, y1), (x1, y2), and (x1, y1). The example shown in FIG. 6 is one in which the coordinates of the base of the thumb are detected as (x1, y1), the coordinates of the tip of the thumb are detected to (x2, y2), and the point of contact between the extension of these two sets of coordinates with the frame of the touch panel 10 is at the coordinates (0, 0).

In this case, if the user causes the base of the thumb to touch the frame of the touch panel 10 and the thumb is caused to hover in the extended state, such as in FIG. 3, as shown in FIG. 6, the upper-left of the image displayed on the display 30 is moved so as to be positioned from the point (0, 0) to the point (x2, y2) by the image controller 70. As a result, the icon I that had been displayed in another region, accompanying the move of the image, is moved from the center coordinates (x3, y3) to (x4, y4).

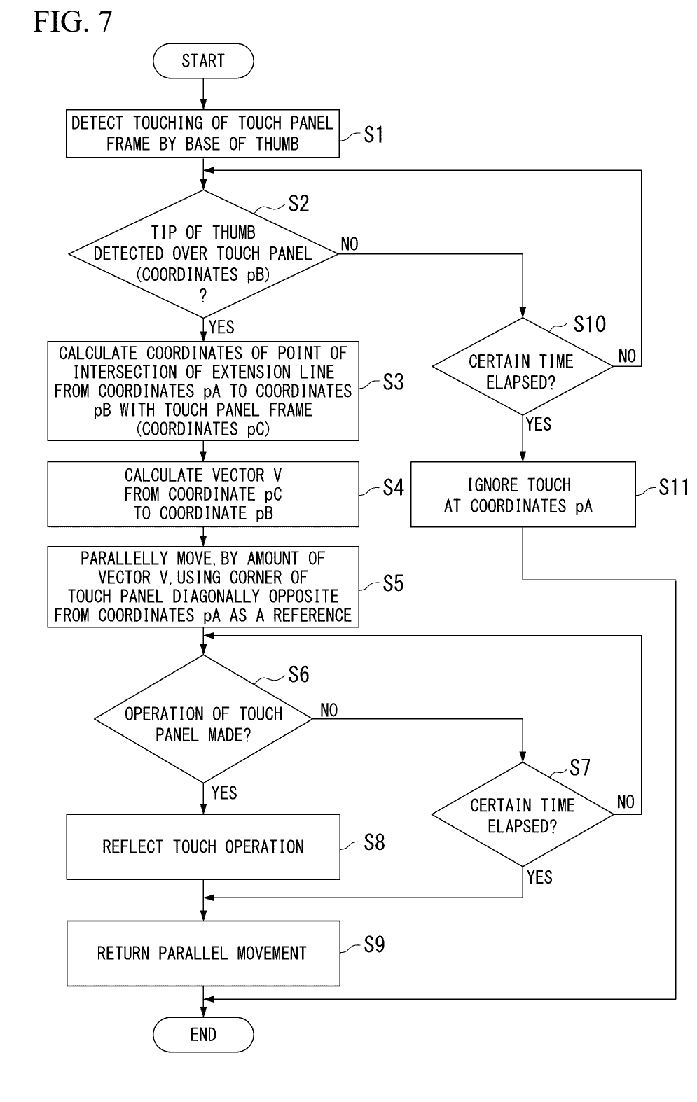

Next, the processing procedure for detecting the base of the thumb touching, detecting the tip of the thumb, and moving the image will be described. FIG. 7 is a flowchart showing the processing procedure according to the present embodiment.

(Step 1) The contact determination unit 43 and the position determination unit 42 determine whether or not the base of the thumb has touched a prescribed region of the touch panel 10. If the determination is made that the base of the thumb of the user has touched the prescribed region of the touch panel 10, the position determination unit 42 detects the coordinates (pA) of the base of thumb touching the touch panel 10.

(Step S2) The contact determination unit 43 determines whether or not the thumb of the user is in the hovering state. If the determination is made that the thumb of the user is in the hovering state (YES at step S2), the position determination unit 42 detects the coordinates (pB) of the tip of the thumb, generates a trigger signal, and outputs the generated signal to the notification unit 50. Next, the notification unit 50 outputs to the image controller 70 movement start information in accordance with an input trigger signal, and processing proceeds to step S3. If the contact determination unit 43 determines that the thumb of the user is not in the hovering state (NO at step S2), processing proceeds to step S10.

(Step 3) The image controller 70, in accordance with the results input from the sensor 90, distinguishes that the display 30 of the terminal 1 is being held in portrait format and switching to the processing performed in the case of holding in portrait format. Next, the image controller 70 calculates the coordinates (pC) of the point of intersection of the line of extension from the coordinates (pA) to the coordinates (pB) with the frame of the touch panel 10.

(Step S4) The image controller 70 calculates the vector V from the coordinates (pC), which was calculated in step S3, to the coordinates (pB).

(Step S5) The image controller 70 causes parallel movement of the image on the display 30 by the amount of the calculated vector V, using the corner of the touch panel 10 diagonally opposite from the coordinates (pA) as a reference.

(Step S6) The contact determination unit 43 determines whether or not an operation has been made on the touch panel 10. If the contact determination unit 43 determines that an operation of the touch panel 10 has been made (YES at step S6), processing proceeds to step S8, and if the determination is that an operation of the touch panel 10 has not been made (NO at step S6), processing proceeds to step S7.

(Step S7) The contact determination unit 43 determines whether or not a certain pre-established amount of time has elapsed. If the contact determination unit 43 determines that the certain amount of time has elapsed (YES at step S7), processing proceeds to step S9, and if the determination is made that the certain amount of time has not elapsed (NO at step S7), return is made to step S6.

(Step S8) If the coordinates detected by the operation performed at step S6 are coordinates within a prescribed region, the touch panel information converter 61 converts the coordinates, and if the detected coordinates are not coordinates within the prescribed region, it does not convert the coordinates. Next, the touch information reflection unit 62 performs prescribed processing, based on the coordinates input from the touch panel information converter 71.

(Step S9) After completion of the prescribed processing of step S8 or after the elapse of the certain amount of time at step S7, the touch information processor 60 outputs to the notification unit 50 information indicating that processing has been completed. Next, the notification unit 50 generates movement stop information, in accordance with the input information indicating that processing has been completed, and outputs the generated movement stop information to the image controller 70. Next, the image controller 70, in accordance with the input movement stop information, returns the image that had been parallel-moved at step S5 to the original position, and ends processing.

(Step S10) If the determination is made that the thumb of the user is not in the hovering state, the contact determination unit 43 determines whether or not a certain pre-established amount of time has elapsed. This certain amount of time may be the same as or different from the certain amount of time in step S7. If the contact determination unit 43 determines that the certain amount of time has elapsed (YES at step S10), processing proceeds to step S11, and if the determination is made that the certain amount of time has not elapsed (NO at step S10), return is made to step S2.

(Step S11) The contact determination unit 43 ignores the touching at the coordinates of point pA detected at step S1, and ends the processing.

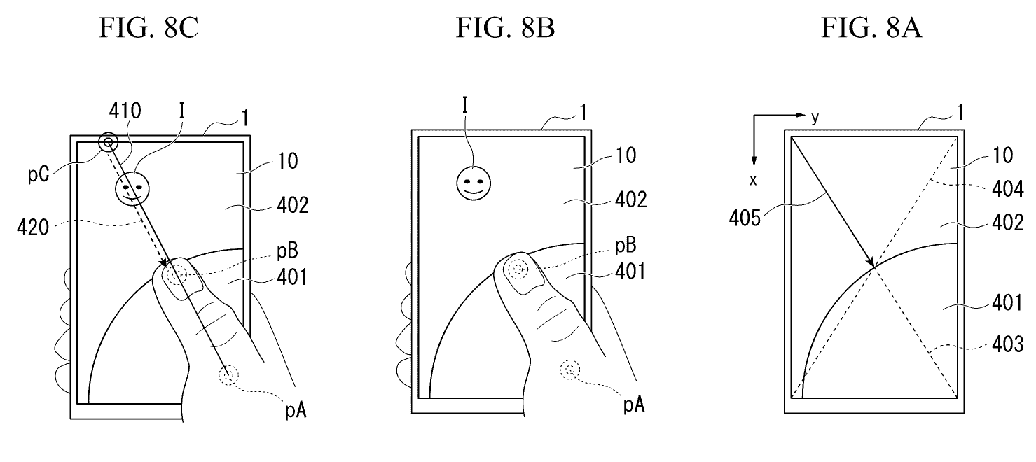

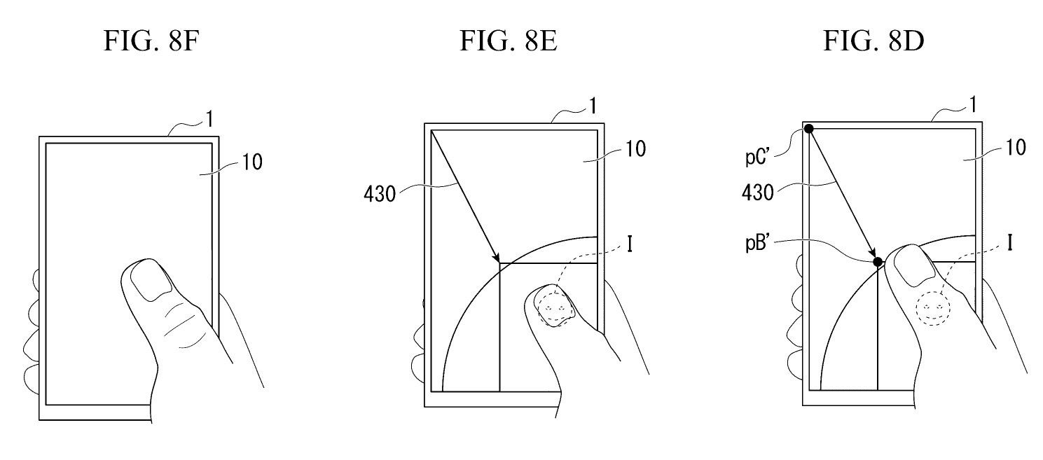

Next, an example of the above-described processing will be described, using FIG. 8A to FIG. 8F.

FIG. 8A to FIG. 8F describe an example of processing according to the present embodiment. In FIG. 8A to FIG. 8F, similar to FIG. 3 to FIG. 6, the long-side direction of the display 30 is taken to be the x-axis direction and the short-side direction thereof is taken to be the y-axis direction. The icon I is associated with an application. FIG. 8A to FIG. 8F describe an example for the case in which the user launches the application associated with the reference symbol I.

FIG. 8A describes the region 401 that the right thumb can operate and the maximum vector 405 with which the image can be moved. The reference symbols 403 and 404 are diagonal lines in the touch panel 10. With the terminal 1 held by one hand, the range that can be operated by the thumb is a region larger than the vertical width and horizontal width of the touch panel 10. If the user wishes to operate an image displayed within the region 401, the user touches the location to be operated. If the user wishes to operate an image displayed in the region 402 outside the region 401, the user's thumb holds the hovering state for a certain amount of time. In response to this operation, the image display on the display 30 parallelly moves by the amount of the vector V. Because the maximum vector V that can be moved is set so that it is the point of intersection between the diagonal lines 403 and 404, it is possible to cover the entire region with one movement. As a result, an image in the region that could not be reached by the thumb can be pulled in with one operation. Also, an image in the region that could not be reached by the finger before movement will not move outside the screen after movement of the image.

FIG. 8B describes the coordinates (pA) of the base of the thumb and the coordinates (pB) of the tip of the thumb. Because the user is holding the terminal 1 one with the right hand, the base of the finger of the right hand touches the region set as the frame of the touch panel 10. The user then maintains the hovering state of the tip of the thumb, aimed at the icon I that cannot be reached by the thumb, for a certain amount of time. As a result, the determination unit 40 detects the coordinates (pA) of the base of the thumb and the coordinates (pB) of the tip of the thumb.

FIG. 8C describes the coordinates (pC) of the point of intersection of the extension line from the coordinates (pA) to the coordinates (pB) with the frame of the touch panel 10. The image controller 70 calculates the coordinates (pC) of the intersection of the extension line 406 from the detected coordinates (pA) of the base of the thumb and the coordinates (pB) of the detected tip of the thumb with the frame of the touch panel 10. Next, the image controller 70 calculates the vector 420 from the coordinates (pC) to the coordinates (pB). The calculation of the coordinates (pC) and the vector v may be performed by the determination unit 40. The detected coordinates may be the coordinates, for example, the center-of-gravity of a prescribed region.

FIG. 8D describes the vector 430 for causing movement. The image controller 70 converts the calculated vector 420 to the vector 430, with the corner on the diagonal line of the holding hand position as a reference. This converts the coordinates (pC) to (pC′) and the coordinates (pB) to (pB′). Then, the image controller 70 parallelly moves the image displayed on the display 30 by the amount of the vector 430 from the coordinates (pC′) to (pB′). As a result, the upper-left coordinates (pC′) of the image that had been displayed on the display 30 moves to the coordinates (pB′). In response to this movement, the icon I moves to a region which the thumb can reach.

FIG. 8E describes the tapping of the icon I by the user. After the image is moved as shown in FIG. 8D, in order to select the desired icon I, the user moves the tip of the thumb and taps the icon I.

FIG. 8F describes the selection of the icon I and the launching of the application. If the icon I is selected as shown in FIG. 8E, the touch information processor 60 launches the application associated with the selected icon I, and then the image controller 70 returns the image that had been parallel-moved by the amount of vector 430 to its original position. As a result, the display 30 displays an image after the launching of the application. If, however, after moving the image as shown in FIG. 8D, the touch panel 10 is not touched for a certain amount of time, the image controller 70 returns the image that had been parallel-moved by the amount of the vector 430 to its original position.

Although FIG. 8A to FIG. 8F describe an example in which the user selects the icon I that is displayed on the display 30, this is not a restriction. For example, if the user performs a swipe, a double-tap or the like with respect to the image after movement, processing is performed by the touch information processor 60 in response to the operation that has been made.

Also, although in the present embodiment the description has been for an operation made by the thumb of the right hand, with the terminal 1 held in the right hand, the same processing as shown in FIG. 7 can be performed for the case of the operation being made by the thumb of the left hand, with holding being done by the left hand.

If the touch panel 10 and the display 30 are integrated as one and have a built-in infrared light source, the detection of the finger shape and hovering may be performed by the backlight difference method, wherein a signal including the light reflected from that light source and then a signal according to only external light that does not include the light reflected from the finger are detected in that sequence. In this case, the finger pressure may be detected by analyzing the contact surface area of the touching finger. Also, whether or not the touching finger is the thumb and whether the thumb is in the extended condition may be detected by performing image analysis of the touching finger. Additionally, the height of the finger may be detected and hover detection may be performed by analyzing the signal light intensity detected by the backlight different method.

According to the first embodiment of the present invention, even for a terminal having a large screen, which cannot be reached by a finger when held in one hand, because it is possible to perform prescribed operations by the minimal fingertip operations while holding with one hand, it is possible to improve ease of operation. Although the present embodiment has been described for the case in which the display 30 has been held in portrait format, this is not a restriction. If the terminal 1 has a display 30 with a side length of, for example, shorter than twice the length of the user's thumb, even if the terminal 1 is held in landscape format, the same processing may be performed.

### Second Embodiment

In the present embodiment, the description will be for the example of the vertical/horizontal length of the terminal being longer than twice the length of the user's thumb. For that reason, in the present embodiment the example in which holding and operating is done with one hand, so that the display 30 is in landscape format. The constitution of the terminal 1 is the same as the constitution described in FIG. 1 of the first embodiment.

The terminal 1 in the present embodiment is, for example, a tablet terminal having a 10-inch-class display 30.

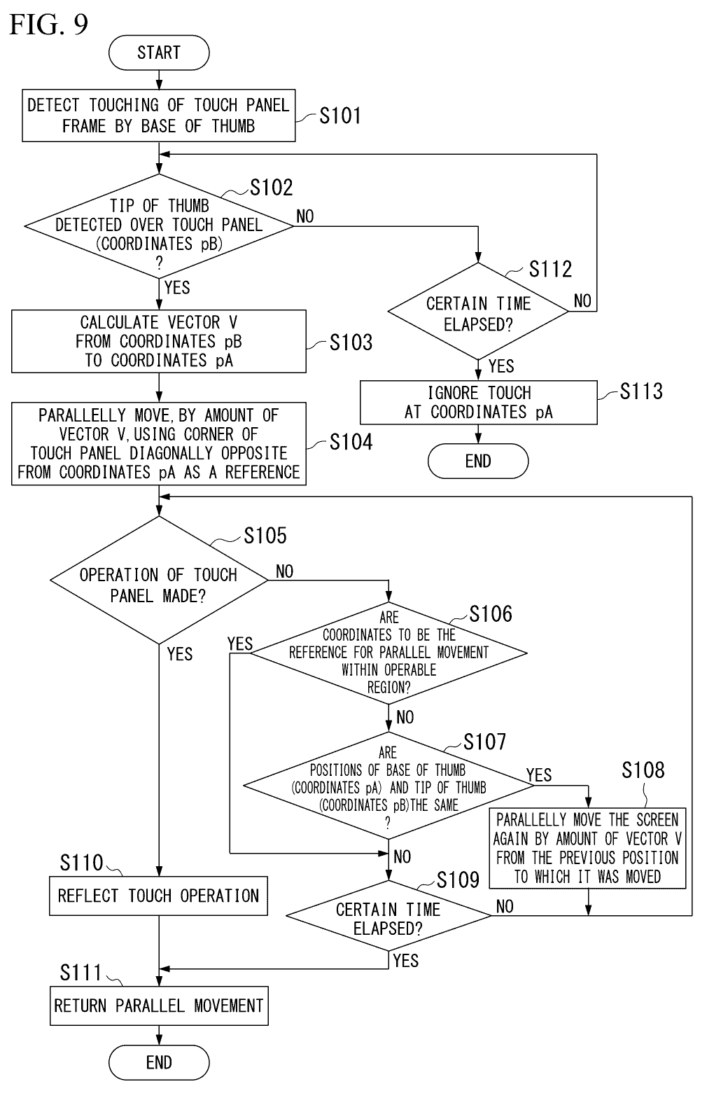

FIG. 9 is a flowchart showing the processing procedure in the present embodiment.

(Steps S101 and S102) The terminal 1 performs the processing of steps S101 to S102 the same as in steps S1 and S2 (FIG. 7).

(Step S103) The image controller 70, in accordance with the result input from the sensor 90, distinguishes that the display 30 of the terminal 1 is being held in landscape format, and switches to the processing performed in the case of holding in landscape format. Next the image controller 70 calculates the vector V from the coordinates (pB) to the coordinates (pA).

(Step S104) The image controller 70 causes parallel movement of the image on the display 30 by the amount of the calculated vector V, using the corner of the touch panel 10 diagonally opposite from the coordinates (pA) as a reference.

(Step S105) The contact determination unit 43 determines whether or not an operation has been made on the touch panel 10. If the contact determination unit 43 determines that an operation of the touch panel 10 has been made (YES at step S105), processing proceeds to step S110, and if the determination is that an operation of the touch panel 10 has not been made (NO at step S105), processing proceeds to step S106.

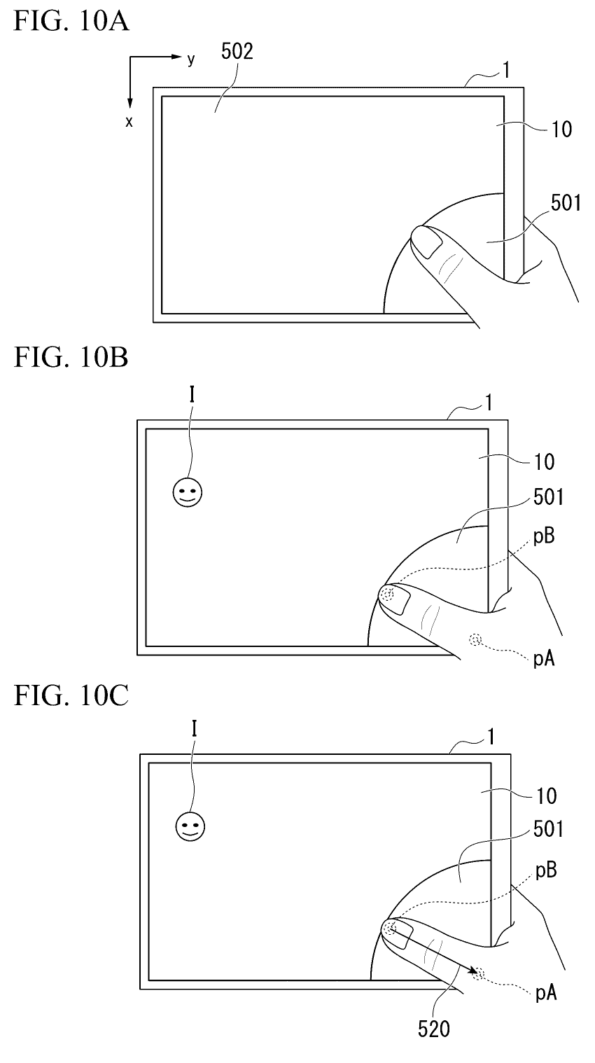

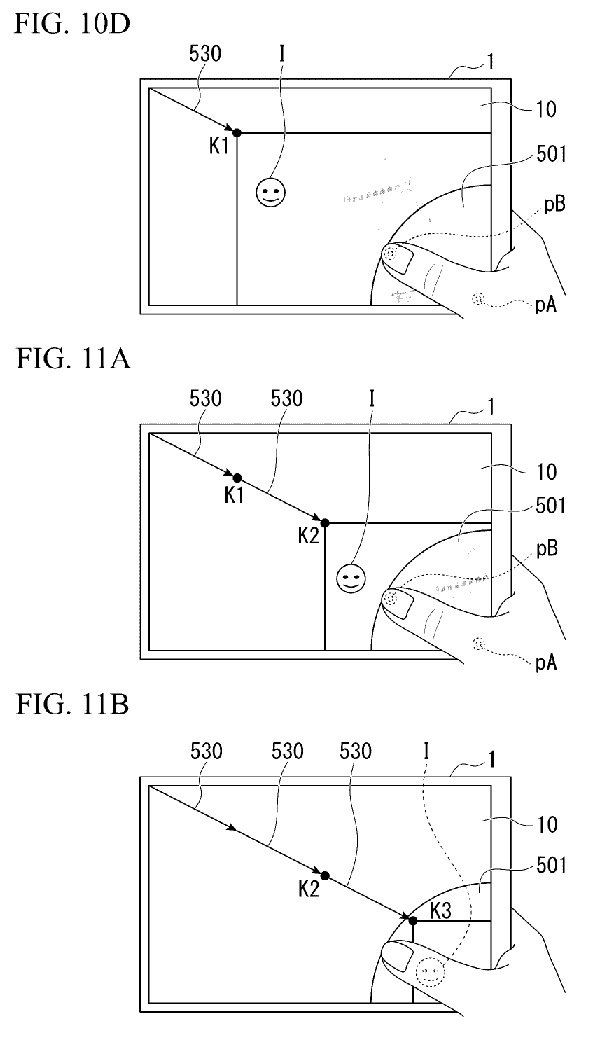

(Step S106) After the parallel movement by the amount of vector V at step S104, the image controller 70 determines whether or not coordinates to be the reference for the parallel movement (for example, the coordinates K1 in FIG. 10D) are within a region operable by the thumb of the user (for example, the region 501 in FIG. 10D). Coordinates to be the reference for parallel movement are, if the user is holding the terminal 1 in the right hand, coordinates at the upper-left of the image that has been parallelly moved. If the image controller 70 determines that the coordinates to be the reference for parallel movement are within the region operable by the thumb of the user (YES at step S106), processing proceeds to step S109, and if the determination is made that the coordinates to be the reference for parallel movement are not within the region operable by the thumb of the user (NO at step S106), processing proceeds to step S107.

(Step S107) The image controller 70 determines whether or not the coordinates (pA) of the base of the thumb of the user and the coordinates (pB) of the tip of the thumb have changed. In addition to the coordinates (pA) and the coordinates (pB), the image controller 70 may, based on whether or not the thumb is in the hovering state and whether or not the extended state of the thumb has continued, determine whether or not the image to be used as the reference for parallel movement is in a region that can be operated by the thumb of the user. if the image controller 70 determines that the coordinates (pA) of the base of the thumb of the user and the coordinates (pB) of the tip of the thumb have not changed (YES at step S107), processing proceeds to step S108), and if the determination is made that the coordinates (pA) of the base of the thumb of the user and the coordinates (pB) of the tip of the thumb have changed (NO at step S107), processing proceeds to step S109. If an operation with respect to the touch panel 10 is not detected even after a plurality of executions of steps S105 to S108, because the direction of extension of the thumb of the user is incorrect, it is assumed that the movement of the image has not been proper. In that case, after continuing movement of the image from the coordinates (pA) until it disappears from the position on the diagonal line, the image may be returned to its original position.

(Step S108) The image controller 70 moves the image from the position to which it had been moved the previous time, by the amount of the vector V, and then causes the parallel movement of the screen, after which it returns the processing to step S105.

(Step S109) The contact determination unit 43 determines whether or not a certain prescribed amount of time has elapsed. If the contact determination unit 43 determines that the certain amount of time has elapsed (YES at step S109), processing proceeds to step S111, and if the determination is made that the certain amount of time has not elapsed (NO at step S109), return is made to step S105. This certain amount of time may be the same as or different from that of step S112.

(Steps S110 and S111) The touch information processor 60 performs the processing of steps S110 and S111 in the same manner as steps S8 and S9. After completion of step S111, the touch information processor 60 ends the processing.

(Steps S112 and S113) The determination unit 40 performs the processing of steps S112 and S113 in the same manner as steps S10 and S11. After completion of step S113, the touch information processor 60 ends the processing.

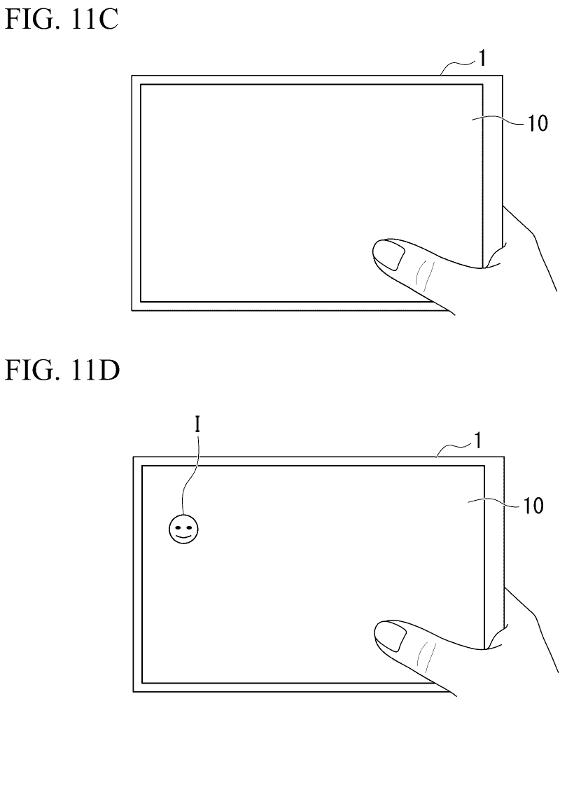

Next, an example of the above-described processing will be described, using FIG. 10A to FIG. 10D and FIG. 11A to FIG. 11D.

FIG. 10A to FIG. 10D and FIG. 11A to FIG. 11D describe an example of the processing according to the present embodiment. In FIG. 10A and FIG. 10D and FIG. 11A to FIG. 11D, the long-side direction of the display 30 is taken to be the x-axis direction and the short-side direction thereof is taken to be the y-axis direction.

FIG. 10A describes the region 501 that is operable by the thumb. In the example shown in FIG. 10A to FIG. 10D and FIG. 11 to FIG. 11D, in the case of holding with one hand, the terminal 1 has a range operable by the thumb that is at least twice the vertical width and the horizontal width of the touch panel 10.

FIG. 10B describes the coordinates (pA) of the base of thumb and the coordinates (pB) of the tip of the thumb. As shown in FIG. 10B, because the user holds the terminal 1 in the right hand, the base of the fingers of the right hand touch a region set as the frame of the touch panel 10. The user maintains the hovering state for a certain time, with the tip of the thumb aimed at the icon I that the thumb cannot reach.

The determination unit 40 detects the coordinates (pA) of the base of the thumb and the coordinates (pB) of the tip of the thumb.

FIG. 10C describes the vector 520 from the coordinates (pB) to the coordinates (pA). The image controller 70 calculates the vector 520 from the coordinates (pB) to the coordinates (pA).

FIG. 10D describes the vector 530 for causing movement. The image controller 70 converts the calculated vector 520 to the vector 530, with the hand holding position and the corner on the diagonal line of the holding hand position as a reference. The image controller 70 causes parallel movement of the image displayed on the display 30 by the amount of the vector 530. As a result, the image that had been displayed on the display 30 moves.

By this parallel movement, the coordinates at the upper-left of the display 30 that are the reference for parallel movement move to the coordinates K1. In the example shown in FIG. 10D, the coordinates K1 are outside the region 501.

FIG. 11A describes the second movement of the image. Because the coordinates K1 that are the reference for parallel movement are moved by the amount of the first vector 530 to outside the region 501, and the icon I does not reached a region that can be operated by the thumb, the image controller 70 again causes parallel movement of the image by the amount of the vector 530. The origin of the vector 530 is the same as the previous ending point K1 of the vector 530. By this parallel movement, the coordinates K1 that are the reference for parallel movement are moved to the coordinates K2. In the example shown in FIG. 11A, the coordinates K2 are outside of the region 501.

FIG. 11B describes the third movement of the image. Because the coordinates K2 that are the reference for parallel movement are also moved by the amount of the second vector 530 to outside the region 501, and the icon I does not region a region that can be operated by the thumb, the image controller 70 again causes parallel movement of the image by the amount of the vector 530. The origin of the vector 530 is the same as the previous ending point K2 of the vector 530. The image controller 70 repeats the parallel movement of image by the amount of the vector 530. By this parallel movement, the coordinates K3 that are the reference for parallel movement, are moved to within the region 501.

FIG. 11C describes the selection of the icon I and the launching of the application. If the icon I is selected, the touch information processor 60 launches the application associated with the icon I and, after the launching, the image controller 70 returns the image that had been parallel-moved by the amount of the vector 530 a plurality of times to its original position. As a result, the display 30 displays an image after the launching of the application. If, however, after moving the image, the touch panel 10 is not touched for a certain amount of time, the image controller 70 returns the image that had been parallel-moved by the amount of the vector 530 to its original position.

FIG. 11D describes an example of the state in which the icon I is not selected. If the state of the user's finger changes from the state shown in FIG. 11B, and a certain amount of time elapses without an operation being made with respect to the touch panel 10, the image controller 70 returns the image that has been moved to the original position.

According to the second embodiment of the present invention, even for a terminal having a large screen in the landscape format, which cannot be reached by a finger when held in one hand, because it is possible to perform prescribed operations by the minimal fingertip operations while holding with one hand, it is possible to improve ease of operation.

In this manner, according terminals 1 of the first and a second embodiments, after the user holds the terminal 1 with one hand, by just maintaining the hovering state of thumb aimed at an image that the user wishes to use, images including images such as an icon that the user wishes to use are automatically pulled into a range to which the finger can reach.

As a result, according to the first and second embodiments, even in the case of a large screen in which, when held by one hand, the finger cannot reach, it is possible to improve the ease of one-hand operation. Although examples have been described in which the touching by the base of the thumb onto a prescribed region of the touch panel 10 is detected, it is sufficient to detect that the terminal 1 is being held, and the detection may be done by a pressure-detecting sensor (not shown) mounted to the side surface of the terminal 1. Also, the terminal 1, in response to the result input from the sensor 90, may perform the processing described in the first embodiment if the display 30 is being held in the portrait format and may perform the processing described in the second embodiment if the display 30 is being held in the landscape format. In this case, when the thumb is in the hovering state, based on the above-described coordinates pA and pB and the size of the display 30 that is stored in the storage 80 beforehand, a determination may be made as to whether or not the vertical/horizontal length of the terminal is longer than twice the length of the user's thumb and, based on the determination result, selection may be made of either the processing of the first embodiment or the processing of the second embodiment.

The processing of the various parts can be implemented by recording a program for implementing the functions of the terminal 1 shown in FIG. 1 of the first and second embodiment into a computer-readable recording medium and having a computer system read and execute the program recorded in the recording medium. The term “computer system” used here includes an operating system and hardware such as peripheral devices. The term “computer system” may encompass a web page providing environment (or displaying environment) if the WWW system is utilized. The term “computer-readable recording medium” refers to a removable medium such as a flexible disk, an optomagnetic disk, a ROM, a CD-ROM, or to a storage device such as a hard disk built into a computer system. Additionally, the term “computer-readable recording medium” may encompass one holding a program over a short time dynamically such as a communication line in the case in which a program is transmitted via a network such as the Internet or via a communication line such as a telephone line and one in such cases in which a program is held for a given period of time as a volatile memory within a computer system serving as a server or client. The above-noted program may be for implementing a part of the above-described functions and may further be one enabling implementation by combination with a program that already has recorded the above-noted functions in a computer system.

### INDUSTRIAL APPLICABILITY

An aspect of the present invention can be applied a terminal and a terminal control method or the like required to improve the ease of operation by one hand, even in the case of a large screen that, when held by one hand, cannot be reached by a finger.

### DESCRIPTION OF THE REFERENCE SYMBOLS

1 Terminal

10 Touch panel

20 Detector

30 Display

40 Determination unit

41 Pressure determination unit

42 Position determination unit

43 Contact determination unit

50 Notification unit

60 Touch information processor

61 Touch information converter

62 Touch information reflection unit

70 Image controller

80 Storage

90 Sensor

I Icon

V Vector

1. A terminal comprising:
a detector that detects contact by a part of a finger at a prescribed location on a display of the terminal and that detects a shape of the finger held over the display; and
an image controller that, based on a detection result detected by the detector, moves an image displayed on the display by parallel movement.

2. The terminal according to claim 1, comprising a converter that converts coordinates on the display after moving the image,
wherein the image controller, based on the coordinates converted by the converter, performs processing with respect to a selected image on the display.

3. The terminal according to claim 1, comprising a sensor that detects an attitude of the display,
wherein the image controller, in accordance with a result detected by the sensor, determines an amount to move the image.

4. The terminal according to claim 1,
wherein the image controller,
in a case that the display is in portrait format, calculates a point of intersection between a line of extension from a position of a base of the finger to a position of a tip of the finger with the display and controls a movement of the image based on a vector from the calculated point of intersection to a position of a tip of the finger, and
in a case that the display is in landscape format, controls a movement of the image based on a vector from the position of the tip of the finger to the position of the base of the finger.

5. A method of controlling a terminal, the method comprising:
detecting, by a detector, contact by a part of a finger at a prescribed location of a display of a terminal and detecting a shape of the finger held over the display; and
moving, by an image controller, based on a detection result detected by the detection step, an image displayed on the display by parallel movement.
